(19) United States
(12) Patent Application Publication
(10) Pub. No.: US 2026/0309886 A1
(43) Pub. Date: Oct. 8, 2026

(54) A METHOD AND SYSTEM FOR MACHINE LEARNING BASED PROCESSING OF SUB-SURFACE ACOUSTIC SIGNALS

(71) Applicant: FNV IP B.V., Nootdorp (NL)

(72) Inventors: Jan Willem BUIST, Nootdorp (NL); Jeronymus Gijsbertus BURGERS, Nootdorp (NL)

(73) Assignee: FNV IP B.V., Nootdorp (NL)

(21) Appl. No.: 19/490,263

(22) PCT Filed: Jun. 10, 2024
(86) PCT No.: PCT/EP2024/065951

§ 371 Date: Dec. 4, 2025

(30) Foreign Application Priority Data
Jun. 15, 2023 (NL) 2035108

(51) Int. Cl. G01V 1/50; G06N 20/00

(52) U.S. Cl. CPC G01V 1/50; G06N 20/00; G01V 2210/6222

(57) ABSTRACT

A method of training a machine learning model to identify an arrival time of an acoustic signal at a sub-surface receiver is disclosed. The method comprises obtaining acoustic data, wherein the acoustic data represents an acoustic signal recorded by a receiver of a probe located in a sub-surface ground volume, said acoustic signal generated by an active signal transmitter. The method further comprises obtaining a target arrival time of the acoustic signal at the receiver and providing the acoustic data to a machine learning model to obtain an output of the machine learning model, the output of the machine learning model comprising a determined arrival time of the acoustic signal at the receiver. The method further comprises adjusting parameters of the machine learning model to reduce an error between the determined arrival time and the target arrival time. Unlocking insights from geodata, the present invention further relates to improvements in sustainability and environmental developments: together we create a safe and liveable world.

### FIELD

This disclosure relates to methods and systems for analysing a region or volume of interest beneath a surface of the earth. More particularly, the disclosure relates to a method and system for determining, using machine learning, an arrival time of an acoustic signal at one or more sub-surface receivers provided within the ground volume. The arrival time can be used to determine a velocity of the acoustic signal in the ground volume and, from this, one or more geodata parameters associated with the ground volume that are relevant for infrastructure planning and engineering can be determined. Unlocking insights from geodata, the present invention further relates to improvements in sustainability and environmental developments: together we create a safe and liveable world.

### BACKGROUND

There is a general and ongoing need for systems and methods for determining sub-surface ground characteristics through the acquisition and analysis of geological data (also referred to as geodata or Geo-Data). In particular, there is a need for systems and methods that can be used to model the properties of a target volume beneath the surface of the earth to provide information that is useful for infrastructure planning. Determination of sub-surface ground properties during the early planning phase of construction projects reduces uncertainty during the location determination, foundation design, and construction phases of a project. This in turn reduces delays, overspend, and unnecessary use of material resources (e.g., concrete) during construction. A thorough understanding of sub-surface characteristics also enables infrastructure projects to be sited and installed appropriately, thereby improving safety.

Of particular interest to infrastructure planners is the behaviour of acoustic signals (also referred to as audio signals, acoustic waves, seismic waves, sound signals, or sound waves) as they propagate through a volume of interest in the ground. The behaviour of these signals can provide insights into the ground composition and structure. In the context of such acoustic signals, two principal wave types that are often studied are compression waves and shear waves. Compression waves, more commonly referred to as P-waves (primary waves), cause particles in a volume to oscillate back-and-forth in a compressing motion in parallel with the direction the wave is propagating. Shear waves, more commonly referred to as S-waves (secondary waves), cause particles in a volume to oscillate with a transverse side to side motion perpendicular to the direction the wave is travelling. The velocities at which these waves travel depend on the material through which they are moving. In particular, the propagation speed of waves through the ground is an important indicator of certain subsurface characteristics, such as soil/rock elasticity or shear properties. Accordingly, by measuring wave velocities and working backward, engineers and infrastructure planners can determine the material properties of the volume through which the signal has travelled.

In some cases, the signals that are studied are passive audio signals created by uncontrolled ambient background noise. That is, signal receivers are configured to detect the wavefield present due to background noise. The background noise may be natural (e.g. due to lapping ocean waves, wind, and other naturally occurring vibrations) or cultural (e.g. due to human activity, including traffic, machinery, etc.). In other examples, the signals that are studied may be created in a more deliberate, controlled manner such as by creating a controlled signal with an active acoustic signal source, for example a hammer drop or explosion. The present disclosure focusses on the latter approach, i.e. the processing and analysis of acoustic signals caused by an active signal source or transmitter.

When studying acoustic signals and their behaviour in a sub-surface ground volume, both down-hole and cross-hole techniques can be used for in-situ measurements. In both of these methods, a receiver located in a borehole measures a signal received from an active acoustic signal source located elsewhere. In a down-hole technique, the signal source may be located within the same borehole as the receiver or, alternatively, at the surface. In a cross-hole technique, a source is located in a first borehole, with a receiver located in a second borehole. In both down-hole and cross-hole techniques, the propagation of the received waves are studied to infer the properties of the material through which the signal from the signal source has travelled. The methods of the present disclosure are relevant to both down-hole and cross-hole acquisition techniques, although down-hole techniques form the primary focus of the discussed implementations.

As will be described in further detail below, the methods and systems of the present disclosure address a need for improved mechanisms for determining signal arrival times at sub-surface receivers. As mentioned above, accurate determination of the arrival time of a signal at a receiver is critical for accurately determining the velocity at which the signal has travelled through the ground volume of interest. Accurate determination of the signal velocity is in turn crucial for accurate determination of geodata parameters of the ground volume. Existing methods and systems for determining the arrival time of a signal at a receiver have many drawbacks. Existing methods lack accuracy and often require additional quality checks. Since the existing methods lack accuracy, the measurement results are often merely indicative or must be independently verified, if that is possible. In addition, existing methods are generally slow to process, often leading to delays on geodata deliverables. The use of additional time and resources leads to less efficient operations, a lack of reliable data and more subsurface uncertainty, which may lead to overparameterization of designs. As a result, this lack of reliability and reproducibility in the determination of geodata parameters may also increase the environmental footprint of design work which is dependent on these geodata parameters. The present disclosure provides methods and systems which address these problems and enables improved determination of said geodata parameters, which increases geodata parameter quality and processing efficiency, and subsequently increases project efficiency, and increases sustainability.

### SUMMARY

According to a first aspect of the present disclosure, there is provided a computer-implemented method of training a machine learning model to identify an arrival time of an acoustic signal at a sub-surface receiver. The term “sub-surface” in this context simply means that the receiver is provided below a surface of the Earth and is configured to detect acoustic signals in such an environment. A “receiver” in this context is any suitable acoustic receiver configured to record acoustic signals (also known as audio signals) below the surface the of Earth. Such receivers can be simple accelerometers, geophones, or more advanced subsurface receivers. The “arrival time” is simply the time at which the acoustic signal of interest first reaches or is first detected by the receiver.

As noted above, the arrival time of the acoustic signal can be used to determine useful engineering geodata parameters that provide insights into the properties of the sub-surface ground volume in which the receiver is provided. By training a machine learning model to identify the arrival time, this important parameter can be determined more efficiently and accurately, with reduced bias and improved reproducibility. As a result, an improved mechanism for determining geodata parameters associated with a ground volume is provided.

The method comprises obtaining first acoustic data, wherein the first acoustic data represents an acoustic signal recorded by a first receiver of a probe located in a sub-surface ground volume, said acoustic signal generated by an active signal transmitter. In other words, an acoustic signal generated by an active signal transmitter, such as a hammer drop or controlled explosion, is detected and recorded by a first sub-surface receiver, and the recorded data is stored (locally or remotely at a database) as the first acoustic data.

The method further comprises obtaining a target arrival time of the acoustic signal at the first receiver. This target arrival time is a known or estimated arrival time of the acoustic signal as determined by a user or a different machine learning model. Most typically, obtaining a target arrival time of the acoustic signal comprises receiving an indication (e.g. a label) of the arrival time, typically through user input or from a database of pre-labelled signal data. In other words, the method may include receiving a labelled version of the first acoustic data wherein the label indicates the arrival time of the acoustic signal at the first receiver. The machine learning model is then trained to replicate the target arrival time (i.e. label), in other words the labelled arrival time can be used as the ground truth in the training method. Accordingly, the method comprises providing the first acoustic data to the machine learning model to obtain an output of the machine learning model, the output of the machine learning model comprising a determined arrival time of the acoustic signal at the first receiver; and adjusting parameters of the machine learning model to reduce an error between the determined arrival time and the target arrival time. In other words, the arrival time as estimated by the machine learning model is compared with the target arrival time as provided, for example, via the labelled acoustic signal data. Parameters of the model are then adjusted in an attempt to minimise the difference between the estimated and the target (labelled ground truth) arrival time, such that through successive iterations the model is trained to predict the arrival time of the acoustic signal at the receiver more accurately.

The disclosed method provides significant improvements in determining the arrival time of an acoustic signal at a receiver. Currently, this process must be performed manually by human experts. This process is not only time-consuming but requires a high degree of skill and experience, as will be explained more fully below. Because the process currently requires a skilled human operator, there is a significant limit on how many signals can be processed in a given time period. Operators must receive a high degree of training and have significant experience before they can accurately estimate the arrival times. Even well trained and experienced human users are invariably prone to biases and inconsistent classification, which impairs the reliability and consistency of the determined signal arrival times. By providing a machine learning model that is trained to determine the arrival time, these drawbacks are addressed. In particular, the determination of the signal arrival time can be made more quickly and more accurately than by a human user, in a manner that is free from biases and inconsistencies. Accordingly, the disclosed method provides a more reliable and consistent estimation of the signal arrival time, meaning that subsequently derived signal velocities and associated geodata parameters can be relied on with a greater degree of confidence. This in turn enables improved planning and safety for infrastructure and construction projects.

The method may advantageously involve analysing more than one set of audio data. For example, the method may involve first and second audio data, representative of two signal recordings performed at two different recording locations. As will be described in more detail below, the two signal recordings can be performed either by two distinct receivers, or by a single receiver sequentially provided at different locations in the ground volume. By analysing the signal at two receiving locations, the time taken for a signal to traverse between the two receiving locations can be determined as described in more detail below. This provides an accurate and reliable way to measure the average velocity (also referred to as the “interval velocity”) of the signal over that distance between the two recording locations. This in turn enables various geodata parameters for the ground volume surrounding the two receiver receiving locations to be determined in an accurate and reliable manner.

One way of providing first and second audio data for analysis is to estimate the arrival time of a same, single signal at two receivers. As noted above, this provides a reliable and accurate mechanism for analysing the behaviour (in particular the velocity) of the signal within the ground volume around the receivers. In this implementation, the method may therefore comprise obtaining second acoustic data, wherein the second acoustic data represents the acoustic signal as recorded by a second receiver provided in the sub-surface ground volume. In other words, the second receiver detects the same signal as the first receiver, at a different point in time (i.e. whichever receiver is further from the transmitter generally detects the signal later). The second receiver may be part of the same probe as the first receiver or, alternatively, the two probes may be independent. Similarly to the signal data recorded at the first receiver, the signal data recorded at the second receiver can be used within a machine learning context to train a machine learning model to estimate signal arrival times. In particular, the method may comprise obtaining a target arrival time of the acoustic signal at the second receiver; providing the second acoustic data to the machine learning model to obtain an output of the machine learning model, the output of the machine learning model comprising a determined arrival time of the acoustic signal at the second receiver; and adjusting parameters of the machine learning model to reduce an error between the determined arrival time and the target arrival time for the second receiver. In other words, the second acoustic signal data is treated similarly to the first acoustic signal data and contributes to training of the machine learning model. The considerations and available implementations described above for the first acoustic data thus also apply to the second acoustic data.

As already noted, another way of obtaining first and second acoustic data is to use a single receiver and measure multiple signal arrivals with the receiver at two or more locations. This provides an alternative mechanism for obtaining multiple sets of acoustic data without the need for multiple receivers. This approach is particularly appropriate for Seismic Cone Penetration Test (SCPT) implementations, where the signal transmitter is provided on the ground surface and a receiver within a penetration probe inserted into the ground volume of interest detects the signal. In implementations such as this where there is a single receiver, the method may therefore further comprise obtaining second acoustic data, wherein the second acoustic data represents a second acoustic signal as recorded by the first receiver when located at a different location in the sub-surface ground volume. For example, the first receiver may be located at a different depth. As in previously described implementations, the second acoustic data (in this example recorded by the first receiver at a different location, rather than by a second receiver) can be used within a machine learning context to train a machine learning model to estimate signal arrival times. In particular, the method may comprise: obtaining a target arrival time of the second acoustic signal at the first receiver; providing the second acoustic data to the machine learning model to obtain an output of the machine learning model, the output of the machine learning model comprising a determined arrival time of the second acoustic signal at the first receiver; and adjusting parameters of the machine learning model to reduce an error between the determined arrival time and the target arrival time for the second acoustic signal at the first receiver. In other words, the second acoustic signal data again contributes to training of the machine learning model, as in previous implementations. The considerations and available implementations described above for the first acoustic data and second acoustic data thus also apply to the second acoustic data in this single-receiver implementation.

Advantageously, in implementations where first and second acoustic data is recorded (whether by two receivers or by a single receiver at two locations), the method may comprise providing the first and second acoustic data to the machine learning model as a combined input. In other words, the machine learning model is trained on both the first and second acoustic data simultaneously. As a result, the machine learning model is trained to treat the first and second acoustic data in a similar manner, or more particularly to label the first and second data in a similar manner. The combined input of the first and second audio data can be considered as a two-channel input, similarly to how a machine learning model may take three input channels (red, green and blue) when processing an RGB image. The present inventors have determined that this strategy of providing the first and second acoustic data as a combined input improves the training process and results in more reliable and accurate determination of signal arrival times, because the model effectively learns to recognise patterns and trends that are common to both signal recordings. Because both the first and second acoustic data are representative either of the same single signal generated at the active signal source (in the case of two receivers) or of two similar signals recorded by the same receiver (in the case of a single receiver), it is beneficial to train the machine learning model to treat the resulting acoustic data as being related. This is achieved by providing the acoustic data as a combined input. In an implementation, more than two receivers may be used, for example, three, or more receivers.

As noted above, generally the study of acoustic signals travelling through a sub-surface medium involves detection and classification of compression-related components (commonly referred to as P-waves) and shear-related components (commonly referred to as S-waves) of the signal. Accordingly, in the presently disclosed method the first and/or second acoustic data may comprise data representative of a compression-related signal component or a shear-related signal component.

The shear-related component relates to characterisation of a shear wave, which can be a true shear (body) wave or a flexural surface wave from which shear wave characteristics can be determined. For example, in the case where the active signal transmitter is provided on the surface of the ground and the receiver(s) measures the transmission of the transmitted signal from the surface into the sub-surface volume, the shear-related component may be a true shear body-wave. Alternatively, where the signal transmitter is provided in the same borehole as the receiver(s), optionally as part of the same probe, then the shear-related component detected represents a flexural surface wave that travels along the inner surface of the borehole. These flexural waves are not true shear waves. However, they can be used to derive an approximation of shear-related characteristics such as the shear wave velocity. Hence, these flexural waves may still be considered as shear-related signal components.

In implementations where the first and/or second acoustic data comprises data representative of a shear-related component, the first and/or second acoustic data may advantageously comprise data representative of two shear-related components that are oppositely polarised, for example two flexural waves. In other words, the acoustic signal transmitter may generate an acoustic signal having two oppositely polarised shear components, which then generate two oppositely polarised flexural waves in the borehole. These oppositely polarised flexural waves can then be detected by the receiver(s). Providing two oppositely polarised signal components in this manner makes it easier to determine the arrival time of the signal at the receiver, as described more fully below. Where a signal comprises data representative of two oppositely polarised components, these components can be provided to the machine learning model as a combined input in a similar manner as described above.

The machine learning model may determine the arrival time of the acoustic signal in any appropriate manner. In one advantageous implementation, for each input acoustic data (i.e. the first and, optionally, second acoustic data described above), the machine learning model is configured to determine the arrival time of the acoustic signal by: separating the acoustic data into a noise portion and a signal portion; determining a transition point between the noise portion and the signal portion, which comprises of the signal of interest, other signals, and background noise; and outputting the transition point as the estimated arrival time of the acoustic signal. Separating the acoustic data into a noise portion and a signal portion can be performed in any suitable manner and the particular implementation chosen will be determined by the type of machine learning model used. In one implementation, the model is a segmentation model and segments the signal into signal and noise portions. In another implementation, the model is an image recognition model which learns to identify through image recognition processes the transition in the signal trace between signal and noise. Hence, as can be seen the model can be an image recognition model or a signal processing model. Other approaches that can be used include a classification strategy, where the model classifies whether a sample of the trace is signal or noise, or alternatively an estimation method where the model determines where the transition point should be. In some cases, the machine learning model directly outputs a velocity or interval velocity of the acoustic signal. In an implementation, the model is a combination of a segmentation model and a classification model.

According to another aspect of the present disclosure, there is provided a method of obtaining an estimate of an arrival time of an acoustic signal at a sub-surface receiver using a machine learning model trained according to any of the methods described herein. This method may therefore be considered as representing a use phase for the trained machine learning model. The method comprises: obtaining input data comprising first acoustic data, wherein the first acoustic data represents an acoustic signal recorded by a first receiver of a probe located in a sub-surface ground volume, said acoustic signal generated by an active signal transmitter; and applying the input data to a machine learning model trained according to any of the methods disclosed herein to obtain an output of the machine learning model as the estimate. In other words, acoustic signal data recorded by a signal receiver (such as one of the receivers described above) is provided as an input to a trained machine learning model, and the machine learning model outputs an estimated arrival time of the acoustic signal at the receiver as its output. As described above, this provides an improved mechanism for determining the arrival time of an acoustic signal at a receiver which provides faster, more accurate, more reliable and more reproducible estimates than is possible when using human interpreters. As noted above, this in turn enables important geodata parameters relating to the sub-surface volume to be determined more quickly and with greater levels of confidence.

As in the case of training the machine learning model described above, during the use phase the input data may also comprise more than one set of acoustic data. For example, as discussed above, the input data may comprise acoustic data recorded by more than one receiver or may comprise acoustic data recorded by a single receiver at multiple locations.

In one implementation, the input data provided to the machine learning model may further comprise second acoustic data, wherein the second acoustic data represents the acoustic signal as recorded by a second receiver provided in the sub-surface ground volume. In other words, the second receiver detects the same signal as the first receiver, at a different point in time. In this case, the output of the machine learning model thus further comprises an estimate of the arrival time of the acoustic signal at the second receiver. The above discussion of the details of the first and second receivers applies here too, in particular the receivers can be part of the same or different sub-surface probes.

In an alternate implementation, as discussed above, a single receiver may be used and the second acoustic data may thus comprise acoustic data recorded by the same first receiver at a different location in response to a subsequent similar acoustic signal. In that case, the input data again further comprises second acoustic data, wherein in this example the second acoustic data represents a second acoustic signal as recorded by the first receiver of the probe when located at a different location in the sub-surface ground volume. In this case the output of the machine learning model further comprises an estimate of the arrival time of the second acoustic signal at the first receiver.

As at training time, when using the machine learning model in the context of first and second sets of acoustic data, the first acoustic data and the second acoustic data may advantageously be provided to the machine learning model as a combined input. This has the same advantages as described above with respect to the training phase, namely that the machine learning model applies a consistent treatment to both recordings, whether this represents recording of the same signal at the first and second receiver or recordings of different signals at the first receiver. This approach is beneficial given that in either implementation these recordings are related to a same single signal generated by the transmitter (in the two-receiver case) or two similar signals generated by the transmitter at different times (in the single-receiver case). Treating the two recordings as a related combined input ensures that the arrival times of the signals as estimated by the machine learning model is more reliable.

The method may further comprise determining an interval velocity of one or more components of the acoustic signals detected by the first and/or second receiver. The term “interval velocity” indicates that the determined velocity is an average velocity across the separation distance between the two locations at which the first and second acoustic data were respectively recorded. If the recorded acoustic signal data is representative of both compression and shear-related signal components, then a distinct interval velocity for each component can be determined. The manner in which the interval velocity is determined will vary based on whether a multiple-receiver or single-receiver setup is used.

In one implementation, where there are multiple receivers and the first and second acoustic data represent a single signal as recorded at first and second receivers, then the interval velocity can be determined based on the estimated arrival time of the acoustic signal at the first and second receivers and a known distance between the first and second receivers. Hence, the method may comprise: based on the estimated arrival time of the acoustic signal at the first and second receivers and a known distance between the first and second receivers, determining an interval velocity of one or more components of the acoustic signal. In other words, based on a known separation of the two receivers and a determined arrival time of the signal at each respective receiver, it can be determined how long it took the signal to travel between the first receiver and the second receiver, and therefore at what velocity the signal was travelling during this time. The term “interval velocity” in this example therefore indicates that the determined velocity is an average velocity across the separation distance between the two receivers.

In a single-receiver implementation, the receiver records data representative of a first signal at a first location in the ground volume. The receiver is then moved to a different, second location in the ground volume and records data representative of a second signal at that new second location. Both the first and second signals are similar signals transmitted by the signal transmitter. In this example, the interval velocity can be determined based on the estimated arrival time of the acoustic signal at the first and second locations and a known distance between the first and second locations. Hence, in this implementation the method may further comprise: based on the estimated arrival time of the first and second acoustic signals at the first receiver and a known distance between the locations in the ground volume where the first receiver respectively detected the first and second acoustic signals, determining an interval velocity of one or more components of the second acoustic signal.

More detail on the precise manner in which the interval velocity can be calculated in each of the above implementations is provided below.

Irrespective of which implementation is used and how the interval velocity is calculated, the method may further comprise calculating, based on the determined interval velocity of one or more components of the first or second acoustic signal, one or more parameters associated with the ground volume. These parameters may represent useful geodata that can provide insights into the structure, stability or other characteristic of the ground volume in which the receiver(s) are provided. These insights and parameters can in turn inform key infrastructure and engineering decisions for example in relation to siting and construction of buildings or installations. Some examples of the one or more parameters include: a small-strain shear modulus associated with the ground volume; a small strain Poisson's ratio associated with the ground volume; a small strain Young's modulus associated with the ground volume; and a bulk modulus associated with the ground volume. Each of these parameters can be determined more accurately and reliably through use of the presently disclosed methods and systems, in particular because calculation of each of these variables relies on determining an arrival time of a signal at the receiver(s) and, from this, the velocity of one or more components of the signal through the ground volume of interest.

The disclosed method may further comprise presenting, on a display, the estimated arrival time of an acoustic signal at the first and/or second receiver. Advantageously, the estimated arrival time can be overlayed onto a visual depiction of the signal trace of the acoustic signal as recorded by the receiver(s). This makes it easy to check and interpret the estimated arrival time, enabling improved quality control. Having performed a check, the user may provide input confirming whether the arrival time as estimated by the machine learning model is accepted or not, for example based on whether the estimated arrival time appears accurate to the user. This can again act as a form of quality control or auditing to ensure proper functioning of the machine learning model, which may be particularly useful in the early stages of training when the model is still at a rudimentary level. Where such quality control checks are carried out by a user, the method may further comprise receiving an input representing a confirmation of the estimated arrival time of the acoustic signal at the first and/or second receiver. For example, the user can provide an input confirming that an arrival time estimated by the machine learning model appears accurate. Alternatively, the method may comprise receiving an input representing a correction and/or rejection of the estimated arrival time of the acoustic signal at the first and/or second receiver. This may occur if the user determines that the estimated arrival time output by the machine learning model appears erroneous.

As noted above, the probe containing the first and, optionally, the second receiver may be provided in a sub-surface borehole. In one particular implementation, the probe comprises a P & S suspension logging (PSSL) tool or a Seismic Cone Penetration Test (SCPT) tool. The function and utility of both of these tools, which are inserted into the ground to analyse a ground volume, is enhanced through incorporation of the methods disclosed herein. Optionally, the probe may comprise the active signal transmitter. This is typically more relevant for PSSL type setups where a single probe containing two or more receivers and the signal transmitter is typically used. This reduces the number of separate components that need to be used, simplifying the geodata acquisition process.

The machine learning model used may be any suitable machine learning model. In one particular implementation, the machine learning model advantageously comprises a Convolutional Neural Network (CNN) which is a type of network particularly well suited to the methods of the present disclosure.

As noted above, the present method relates to acquisition of geodata using one or more receivers provided below the Earth's surface in a sub-ground volume. Accordingly, obtaining the input data of the disclosed methods may comprise: inserting the probe comprising the receiver(s) into the sub-surface ground volume; creating, using the active signal transmitter, the acoustic signal; and recording the acoustic signal at the receiver(s) to generate the acoustic data. This applies equally to the first and second receiver and any corresponding first and second acoustic data recorded by those receivers. The same approach applies if there are more than two receivers or signals.

Advantageously, the disclosed methods may be repeated both at a single depth and/or at multiple depths below the Earth's surface. This applies to both single and multiple receiver implementations. Accordingly, the disclosed method may further comprise repeating any of the disclosed methods at the same depth or moving the probe to a new depth and repeating the method at the new depth.

According to another aspect of the present disclosure, there is provided a system comprising one or more processors and one or more memories having stored thereon computer readable instructions configured to cause the one or more processors to perform any of the methods disclosed herein.

According to yet another aspect of the present disclosure, there is provided one or more computer readable media comprising instructions, that, when executed by one or more data processing apparatus, cause the one or more data processing apparatus to perform any of the methods disclosed herein.

According to yet another aspect of the present disclosure, there is provided a machine learning model stored on one or more computer readable media, wherein the model has been trained according to any of the training methodologies disclosed herein.

### BRIEF DESCRIPTION OF THE DRAWINGS

In order to describe the manner in which the above-recited and other advantages and features of the disclosure can be obtained, a more particular description of the principles briefly described above will be rendered by reference to specific embodiments thereof which are illustrated in the appended drawings. Understanding that these drawings depict only exemplary implementations of the disclosure and are therefore not to be considered to be limiting of its scope, the principles herein are described and explained with additional specificity and detail by way of example to illustrate aspects of the disclosure and with reference to the accompanying drawings, in which:

FIG. 1 shows an example probe comprising receivers and an active acoustic signal transmitter suitable for implementing the ground analysis methods of the present disclosure;

FIGS. 2 and 3 show compression-related signal traces representative of acoustic signal data recorded at first and second receivers of a probe responsive to detection of an acoustic signal;

FIGS. 4 and 5 show shear-related signal traces representative of acoustic signal data recorded at first and second receivers of a probe responsive to detection of an acoustic signal;

FIG. 6 shows schematically an approach for training a machine learning model to estimate an arrival time of an acoustic signal at a receiver based on recorded acoustic data;

FIG. 7 shows schematically a more detailed approach for training a machine learning model to estimate acoustic signal arrival times according to the present disclosure;

FIG. 8 shows schematically a method for using a trained machine learning model to estimate acoustic signal arrival times according to the present disclosure;

FIGS. 9 and 10 show shear-related signal traces representative of acoustic signal data recorded at first and second receivers of a probe responsive to detection of an acoustic signal, where the signal comprises two oppositely polarised shear components; and

FIG. 11 shows a block diagram of a computing device which can be used to implement the disclosed methods.

### DETAILED DESCRIPTION

The following is a description of certain embodiments of the invention, given by way of example only and with reference to the drawings.

Various implementations of the disclosure are discussed in detail below. While specific implementations are discussed, it should be understood that this is done for illustration purposes only. A person skilled in the relevant art will recognize that other components and configurations may be used without parting from the spirit and scope of the disclosure. Thus, the following description and drawings are illustrative and are not to be construed as limiting. Numerous specific details are described to provide a thorough understanding of the disclosure. However, in certain instances, well-known or conventional details are not described in order to avoid obscuring the description. A reference to an implementation in the present disclosure can be a reference to the same implementation or any other implementation. Such references thus relate to at least one of the implementations herein.

The terms used in this specification generally have their ordinary meanings in the art, within the context of the disclosure, and in the specific context where each term is used. Alternative language and synonyms may be used for any one or more of the terms discussed herein, and no special significance should be placed upon whether or not a term is elaborated or discussed herein. In some cases, synonyms for certain terms are provided. A recital of one or more synonyms does not exclude the use of other synonyms. The use of examples anywhere in this specification including examples of any terms discussed herein is illustrative only and is not intended to further limit the scope and meaning of the disclosure or of any example term. Likewise, the disclosure is not limited to various implementations given in this specification.

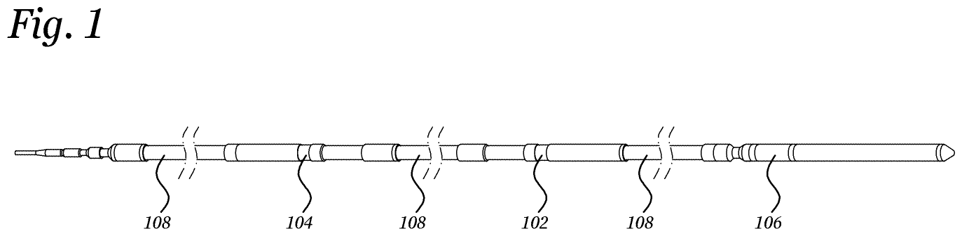

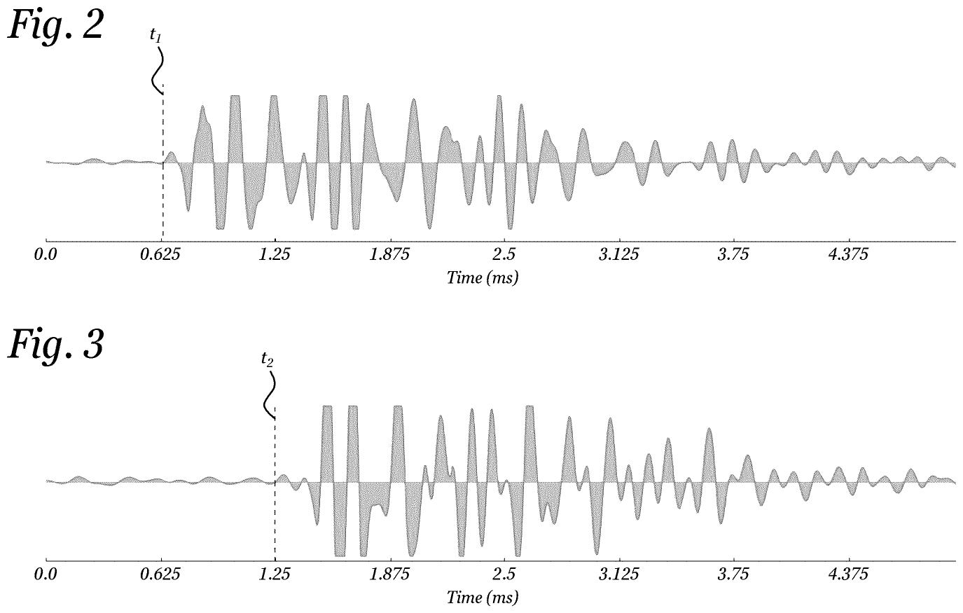

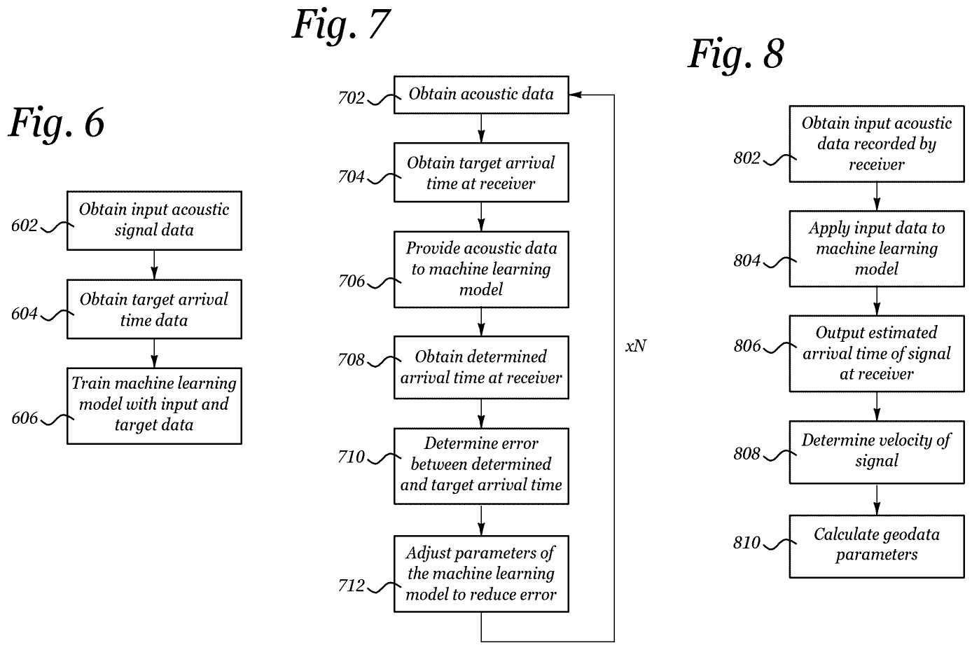

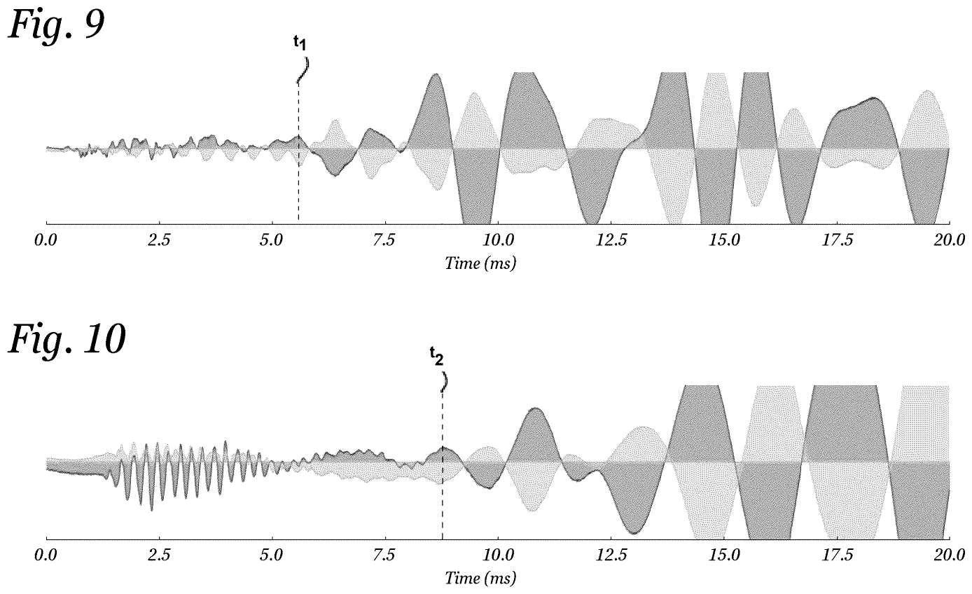

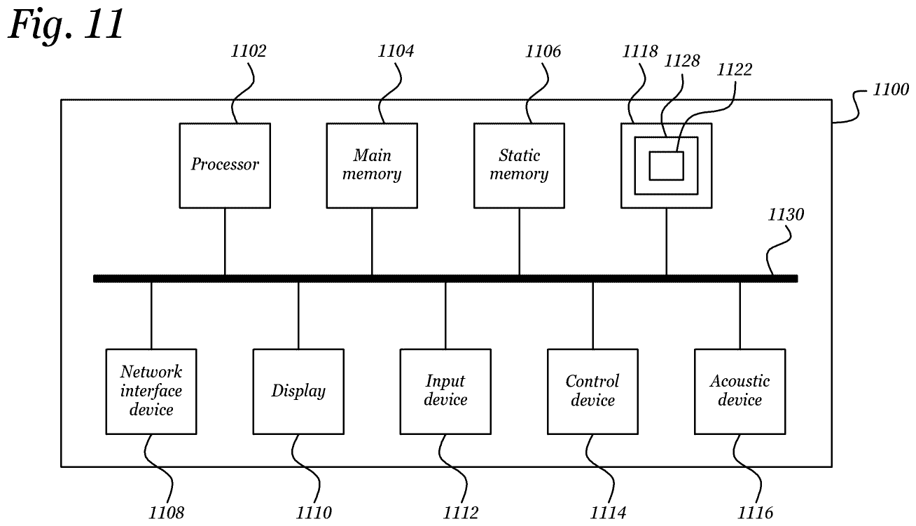

The present disclosure describes improved systems and methods for determining material properties of a sub-surface ground volume, in particular by using machine learning to estimate an arrival time of an acoustic signal at one or more receivers in that ground volume. The determined arrival times can be used to calculate useful geodata parameters associated with the ground volume around the receivers, including material parameters that are useful for infrastructure and construction planning. Beginning with FIG. 1, an example probe that can be used in the context of the disclosed methods is described. Acoustic signal data recorded by one or more receivers of such a probe is discussed with reference to FIGS. 2-5, particularly in the context of determining an arrival time of the acoustic signal at the receivers. A method of training a machine learning model to perform the disclosed methods is described with reference to FIGS. 6 and 7. A method of using a machine learning model, trained according to the disclosed methods, to determine arrival times of acoustic signals within a ground volume is then disclosed with reference to FIG. 8. A variation where the shear component of the generated signal has oppositely polarised shear components is discussed with reference to FIGS. 9 and 10. Finally, a computing device that may be used to perform the disclosed methods is described with reference to FIG. 11.

As described above, the present disclosure relates generally to creating an acoustic signal (which may also be referred to as an “audio signal”) using an active signal transmitter such as a hammer drop or explosive charge. The acoustic signal then passes through a ground volume below the surface of the Earth and is detected and recorded as acoustic data (which may also be referred to as “audio data”) by one or more acoustic receivers (which may also be referred to as “audio receivers”) of a probe provide within the ground volume. Based on characteristics of the recorded signal, in particular the velocity of the signal, geodata parameters can be determined that are useful for engineering and infrastructure planning purposes.

The velocity of the signal can be determined from the fundamental relation V=d/(t−t₀) where V is the (average) velocity of the signal, d is a known distance over which the signal has travelled during the measuring period, t is the arrival time of the signal at the receiver, and to is the time at which the signal was generated. t−t₀ represents the travel time of the signal, i.e. the time it took for the signal to pass through distance d. Parameters d and to can be set to known values at the time of conducting the analysis. Then, by performing the methods of the present disclosure, t (i.e. the arrival time of the signal at the receiver) can be determined. From this, V can be calculated and then subsequently used to determine useful geodata parameters important for engineering and infrastructure planning.

From the above, it will be apparent that accurately and reliably determining the arrival time of the signal, t, at the one or more receivers of the sub-surface probe is of critical importance, because it is the measurement of t which enables the determination of the signal velocity V. Methods for improving the accuracy and reliability of determining the arrival time t of the signal therefore represent the primary focus of the present disclosure.

An example experimental setup for performing an investigation to determine the arrival time t for an acoustic signal travelling through a ground volume of interest will now be described with reference to FIG. 1. It is to be understood that this setup is merely an example and that other experimental setups can be used. In particular, any setup that enables an arrival time of a generated signal at a receiver in a ground-volume to be determined is amenable to the methods of the present disclosure.

Turning to FIG. 1, an example probe 100 that can be used to implement the disclosed methods is shown. Probe 100 can be inserted into a borehole within a ground volume of interest so as to enable analysis of the ground volume to be performed. In this example, the probe contains a first receiver 102 and a second receiver 104, although in some examples the probe 100 may contain only a single receiver or more than two receivers. The receivers 102, 104 can be any audio receiver configured to detect and record acoustic signals in a sub-surface environment. In this example the probe 100 also comprises an active signal transmitter 106, which may also be referred to as an active acoustic signal source. The active signal transmitter 106 is configured to generate an acoustic signal which can propagate through a ground volume and then be subsequently detected by receivers, such as first 102 and second 104 receivers of probe 100. In the example of FIG. 1, the active signal transmitter 106 comprises a hammer that is configured to strike against a plate to generate the acoustic signal. Other mechanisms such as those based on explosive charges are possible for generating the acoustic signal. In some implementations, the active signal transmitter 106 may also not be provided as part of probe 100 but may instead be provided as part of a different probe provided within the same borehole as probe 100. Alternatively, the active signal transmitter may be located elsewhere, such as on the ground surface.

Note that the term “active” in the context of an “active signal transmitter” simply means that the signal transmitter 106 is configured to generate an acoustic signal in a controlled (“active”) manner responsive to operator control, such as actuation of a trigger or transmittal of a command signal. Such active signal generation is in contrast to “passive” acoustic signals, such as may be caused by uncontrolled background noise. While such passive acoustic signals may be recorded and analysed in some geodata acquisition contexts, they are not relevant to the methods of the present disclosure. In the example shown, probe 100 comprises acoustic isolators 108 to isolate the receivers 102, 104 from one another and from the signal source 106. However, these isolators are not essential.

Operation of the probe 100 of FIG. 1 is performed as follows. First, a borehole is drilled into a ground volume of interest. The borehole is of sufficient diameter that the probe 100 can fit into it. The probe 100 is then lowered into the borehole such that the receivers are provided at the desired depth within the ground volume. Where the probe contains more than one receiver, such as in the example of FIG. 1, the depth of the probe may be measured as the depth of the mid-point between the receivers, in this case the mid-point between first receiver 102 and second receiver 104. Once in place, the active signal source 106 is triggered and generates an acoustic (sound) signal. This signal projects outward in the form of waves from the signal source 106 and into the ground volume around the borehole. The signal spreads through the ground volume and re-enters the borehole. Some components of the signal also travel along the interior surface of the borehole, as discussed in more detail below. The signal is then detected at the one or more receivers of the probe. Based on the arrival time of the signal at the receiver(s) and a known distance across which the signal has travelled, the velocity of the signal can be determined. This general principle applies regardless of where the active signal transmitter is placed and how many receivers are provided. Three examples for how calculation of the signal velocity might be determined will now be described to aid understanding.

### Single Receiver

In some examples (not shown in FIG. 1), there may be only a single receiver in the probe 100. In that case, the arrival time of the signal at the receiver, t, is determined. The travel time of the signal is then the difference between the arrival time t and the time at which the signal was generated at the signal source, to. From this, assuming the distance between the signal transmitter and the receiver is known, the velocity of the signal can be determined based on:

$$V = \frac{{d}_{tra \_ rec}}{t - {t}_{0}} ,$$

where V is the signal velocity, d_{tra_rec} is the distance between signal transmitter and the receiver, t is the arrival time of the signal at the receiver and to is the time at which the signal was generated at the transmitter.

Alternatively, in the single receiver implementation, a measurement may be made at first and second depths in the ground volume. In other words, the receiver may detect a first signal at a first depth. The receiver may then be moved to a different depth and may detect a second signal at that new, second depth. In that case, the difference in how long it takes similar acoustic signals to reach the receiver at each depth can be determined. Based on that difference, an interval (i.e. average) velocity over the distance between the first and second depths can be determined. In other words, if the signal travel time to the first depth is t₁−t_{0_1} and the signal travel time of a similar signal to the second depth is t₂−t_{0_2}, then the travel time of such a signal between depth 1 and 2 is (t₂−t_{0_2})−(t₁−t_{0_1}). t_{0_1} is the start time of the first signal and t_{0_2} is the start time of the second signal. The interval velocity of the signal over the distance between the first and second depths, d_{1_2}, is then

$$V = \frac{{d}_{1 \_ 2}}{( ( {t}_{2} - {t}_{0 \_ 2} ) - ( {t}_{1} - {t}_{0 \_ 1} ) )} .$$

This single-receiver-at-multiple-depths approach is particularly relevant for implementations where the signal transmitter is at the ground surface and the single receiver probe is inserted into the ground volume. One example of such an approach is a SCPT probe.

When a single receiver approach is used to detect first and second signals in this manner, the first and second signals are configured to be similar signals having similar or identical initial frequencies and amplitudes. Of course, by the time the signals reach the receiver there may be slight differences at the first and second locations because the signal will have travelled through a different distance of ground volume. As a result, small changes in the signal properties as a result of the soil conditions and differentiation in distance can be observed. However, in practice these changes have been determined to be negligible such that the first and second signals can be treated as being identical. In that case, only the arrival time of each signal at each respective depth needs to be determined, as described above.

### Multiple Receivers

Where a probe contains two or more receivers, as in the case of the probe 100 of FIG. 1, the computation of the signal velocity can be simplified and made more reliable by considering only the distance between two receivers, such as the first 102 and second receiver 104. In more detail, in this case because the first receiver 102 is located closer to the signal source 106, the signal will reach the first receiver 102 before it reaches the second receiver 104. Hence, the first 102 and second 104 receivers record different arrival times, t₁ and t₂ respectively. The velocity of the signal can then be determined based on the difference in arrival times between the two receivers, t₂−t₁, and a known distance, d_{1_2}, between the receivers. In other words, in this example,

$$V = \frac{{d}_{1 \_ 2}}{{t}_{2} - {t}_{1}}$$

where v is the signal velocity, d_{1_2} is the distance between first receiver 102 and second receiver 104, t₁ is the arrival time of the signal at the first receiver 102, and t₂ is the arrival time of the signal at the second receiver 104.

### General Considerations

As described above, regardless of the particular experimental setup and number of receivers used, determination of the signal velocity through a particular portion of ground volume is very useful because this velocity can be used in turn to calculate a variety of important geodata parameters as discussed in more detail below.

Persons skilled in the art will appreciate that while the above discussion has referred, for simplicity, to a single signal having a single signal velocity, V, in reality an acoustic signal generated at or within a ground volume will in fact generate multiple signal components each having a respective component signal velocity. As noted above, an acoustic signal travelling through a ground volume generally has two primary components, a compression-related component and a shear-related component. Compression waves, more commonly referred to as P-waves, cause particles in a volume to oscillate back-and-forth in a compressing motion in parallel with the direction the wave is propagating. Shear waves, more commonly referred to as S-waves, cause particles in a volume to oscillate with a transverse side to side motion perpendicular to the direction the wave is travelling. Both compression and shear related waves can be detected by receivers using the setup described above. The velocities at which these signal components respectively travel again depend on the material through which they are moving, and both the compression wave velocity, vₚ, and the shear wave velocity, vₛ, can be determined using the principles described above.

Concerning the shear wave velocity, the method by which this is in practice determined will vary slightly based on the experimental setup. In particular, when the active signal transmitter is provided on the ground surface or in a different borehole to the receiver(s), then the shear-related components received at the receiver(s) will be true shear (body) waves that have travelled through the body of the ground volume before reaching the receiver(s). Accordingly, a determination of the velocity of the shear-related signal component in that case directly yields vₛ. Alternatively, if the signal transmitter is provided in the same borehole as the receiver(s) (as is the case in the example of FIG. 1), then the most effective way to determine vₛ is to detect flexural waves which transmit up the internal surfaces of the borehole rather than travelling through the body of the ground volume. In that case, a determination of the signal velocity of the shear-related component using the methods described above yields the velocity of these flexural waves. The true shear-wave velocity, vₛ, can then be determined from this flexural velocity in manners known in the art. In further detail, flexural waves have the unique property that in the low frequency domain their propagation velocity is equivalent to the shear wave velocity. Flexural waves are subject to a dispersion effect depending on frequency, which changes the wave velocity. Dispersion is minimal when the wavelength is at least three times the borehole diameter and also in the low frequency range (<2 kHz). For these reasons it is reasonable to assume the flexural velocity is the equal of the true shear wave velocity.

Ultimately, the distinction between true shear waves and flexural waves is not important for understanding the primary methods of the present disclosure and is provided here merely for completeness and to aid understanding. In either case, the end result is a compression wave velocity Up and a shear wave vₛ for the acoustic signal. The methods of the present disclosure directed to determining the arrival time of a signal (component) apply in the same manner regardless of which signal component (be it compression, true shear or flexural shear) is being analysed.

### Acoustic Data Recordings

Turning now to FIGS. 2-7, traces representative of different signal components of the sort that may be detected and recorded by the receivers of the present disclosure are provided. Amplitude of the received signal is shown on the Y-axis and elapsed time is shown on the X-axis. The signal traces of FIGS. 2-7 are provided in the context of the probe 100 of FIG. 1 which has two receivers, hence two signal traces for each type of signal are recorded. However, it will be appreciated that the concepts described apply regardless of how many receivers there are.

FIG. 2 shows a compression-related component (i.e. P-wave) detected by a receiver, in this case the first receiver 102 of probe 100. FIG. 3 shows the same compression-related signal detected by the second receiver 104 of the probe. FIGS. 2 and 3 share the same time axis and, as can be seen, the signal reaches the second receiver 104 later than the first receiver 102 as described above. The arrival time of the compression signal component at the first receiver 102 is again denoted t₁ and is indicated via a dashed line in FIG. 2. The arrival time of the compression signal component at the second receiver 104 is similarly denoted t₂ and is similarly indicated via a dashed line in FIG. 3. As described above, determining both t₁ and t₂ enables the velocity of the compression signal component (P-wave) to be determined based on a known distance between the first 102 and second 104 receiver.

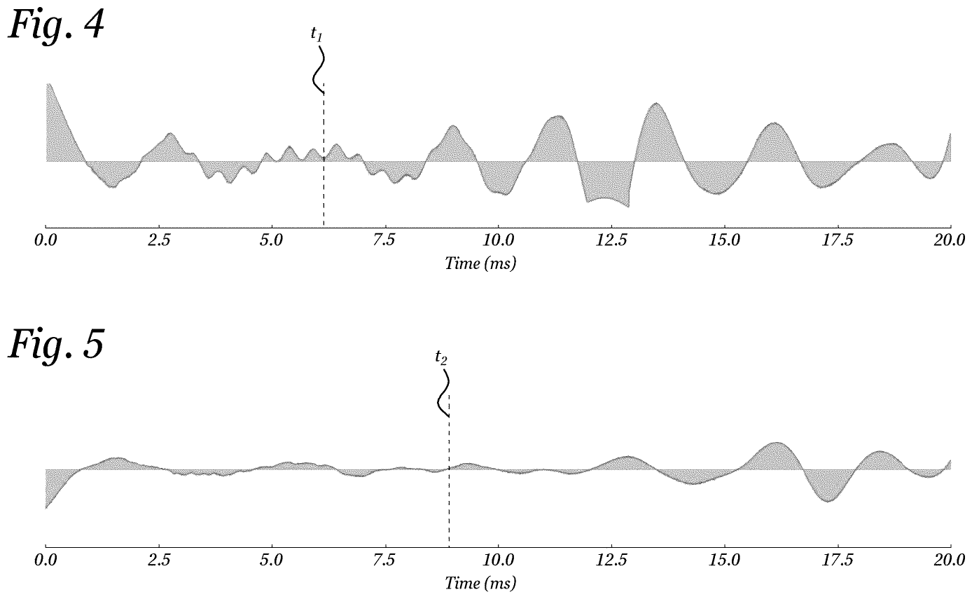

FIGS. 4 and 5 are equivalent to FIGS. 2 and 3 except in that they relate to a shear-related component of the acoustic signal. In this case, the probe 100 is used and so the active signal transmitter 106 is in the same borehole as the receivers 102, 104. For the reasons described above, the shear-related signals detected and shown in FIGS. 4 and 5 are therefore flexural waves that have travelled over the interior surface of the borehole before being detected. However, given the true shear-wave velocity vₛ can still be calculated from the velocity of these flexural waves, we can for simplicity simply refer to the waves of FIGS. 4 and 5 as “shear waves” or “S-waves”, despite the fact that they are strictly speaking flexural waves. The signal trace of FIG. 4 shows the S-wave component of the generated acoustic signal as detected by the first receiver 102. The signal trace of FIG. 5 similarly shows the S-wave component of the same generated acoustic signal as detected by the second receiver 104 a short time later. The arrival time of the shear-related signal component at the first receiver 102 is again denoted t₁ and is indicated via a dashed line in FIG. 4. The arrival time of the shear-related signal component at the second receiver 104 is similarly denoted t₂ and is again similarly indicated via a dashed line in FIG. 5.

By determining t₁ and t₂ for each signal component (compression and shear), the velocity of that component can be determined in the manner described above. In particular, the compression wave velocity vₚ and the shear wave velocity vₛ can be determined. From these velocities, many useful geodata parameters can be determined characterising the ground volume in which the receiver is provided and through which the signal has travelled. Some example parameters include:
The small strain Poisson's ratio, v, defined as:

$$ν = \frac{0.5 \times {( \frac{{ν}_{p}}{{ν}_{s}} )}^{2} - 1}{{( \frac{{ν}_{p}}{{ν}_{s}} )}^{2} - 1}$$

The small strain shear modulus, Gₘₐₓ [kPa], defined as:

$${G}_{max} = ρ \times {ν}_{s}^{2}$$

The small strain Young's modulus, Eₘₐₓ [kPa], defined as:

$${E}_{max} = ρ \times {ν}_{s}^{2} \times [ 2 ( 1 + v ) ]$$

The bulk modulus, K [kPa], defined as:

$$K = ρ ( {ν}_{p}^{2} - \frac{4}{3} {ν}_{s}^{2} )$$

Where vₚ is the P-wave velocity [m/s] and vₛ is the S-wave velocity [m/s] as determined using any of the methods disclosed herein. ρ is the bulk density of formation [Mg/m³], which is typically determined through laboratory tests of soil or rock samples from the ground volume of interest using methods known in the art.

As will be apparent, determination of each of these geodata parameters relies on accurate and reliable determination of the arrival time of each acoustic signal component at a given receiver, because it is this value that enables the compression (Up) and shear (Us) velocities to be determined. Hence, in the above example using the probe 100 of FIG. 1, for both the P and S-wave components, accurate determination of t₁ (arrival time of the signal component at the first receiver 102) and t₂ (arrival time of the signal component at the second receiver 104) is critical. Unfortunately, existing methods for determining the arrival times of signals at receivers are rudimentary and prone to error and bias. This is because arrival time determination is currently an entirely manual process, whereby a highly trained geodata scientist or engineer looks at a signal trace (such as one of the traces shown in FIGS. 2-5) and manually determines at which point the acoustic signal arrived at the receiver. Making this determination is, however, highly non-trivial and requires a great degree of expertise. This is because audio receivers are constantly detecting background noise. As a result, determining the point in a signal trace where the noise ends and the signal of interest (i.e. the signal created by active signal transmitter 106) begins is often very difficult. Consider, for example, the traces shown in FIGS. 2-5. In FIG. 2, the determination of the arrival time is not particularly difficult because the background noise is relatively low such that it is quite simple to spot when the signal of interest arrives, as indicated by the dashed line at t₁. However, the remaining signals are far more difficult. Considering for example FIG. 3, where the background noise amplitude is higher than in FIG. 2 and more closely resembles the initial amplitude of the signal of interest, meaning that determining the transition point between noise and signal (i.e. arrival time t₂) for the signal trace of FIG. 3 is rather more difficult. An engineer would need to be experienced and well-trained to accurately determine the correct arrival time. Turning to FIGS. 4 and 5, accurate determination of the arrival times in these cases is yet more difficult because here the background noise is quite severe. Only a highly experienced and well-trained expert could accurately pick out the arrival times, i.e. the transition from noise to signal of interest, in these traces.

As a result of these difficulties, determining signal arrival times is currently very difficult and slow work that can only be performed by a small number of experienced experts. In addition, even expert analysts can be prone to human error and bias meaning that one expert may tend to characterise signals in a different manner to another expert. This reduces the reliability, reproducibility and consistency of manually determined arrival times even among experts. All of this results in significant shortcomings in the availability, reliability, accuracy and consistency of determined signal arrival times. This in turn means that the useful geodata parameters described above often cannot be determined with a particularly high degree of certainty, and certainly not in a satisfactory timeframe. There is thus a significant need for improved methods of determining signal arrival times at sub-surface receivers. The remainder of this disclosure will therefore set out an improved approach to determining signal arrival times which addresses some of the above-described shortcomings with existing approaches.

### Improved Approach—Using Machine Learning to Determine Signal Arrival Time

The present inventors have identified that the above-identified shortcomings can be effectively addressed by employing a trained machine learning model to determine the arrival time of a given signal component at a receiver. This approach has been found to improve the reliability, accuracy and consistency of determined signal arrival times, which in turn results in determination of more reliable and accurate geodata parameters. Methods for implementing this improved approach will now be described with reference to FIGS. 6-8.

Turning now to FIG. 6, a method of training a machine learning model to identify an arrival time of an acoustic signal at a sub-surface receiver is shown schematically. This training method can be used within the above-described ground analysis context, in other words a machine learning model trained using the method of FIG. 6 can be used to output signal component arrival times which in turn can be used to determine signal component velocities (in particular vₛ and vₚ) and other related geodata parameters such as those described above.

The method of FIG. 6 begins, at step 602, by obtaining input acoustic signal data. This is recorded acoustic data that has been obtained experimentally at sub-surface receivers through the recording of acoustic signals generated by active signal transmitters. For example, the input acoustic signal data may comprise data representative of recorded acoustic signal traces of the sort shown in FIGS. 2-5.

At step 604, the method proceeds by obtaining target signal arrival time data. Target signal arrival time data comprises labels or indicators indicating the signal arrival time associated with each acoustic signal comprised in the input acoustic signal data provided at step 602. For example, if the input acoustic signal data comprises the data associated with the audio trace of FIG. 2, then the target signal arrival time data comprises an indication of t₁ for this trace, i.e. the arrival time of the signal at the receiver. This label can be provided by an expert analyst or by another machine learning network. The target data (labelled arrival time) can then be used within the training method as a “ground truth” for each acoustic signal. The ground truth arrival time is what the machine learning model is attempting to replicate.

At step 606, the method trains a machine learning model using the input acoustic signal data provided at step 602 and the target signal arrival time data provided at step 604. In particular, data associated with an acoustic signal recording is provided to the machine learning model. The machine learning model then predicts, based on the input data, the arrival time of the acoustic signal at the receiver. It is then assessed whether the determined (predicted) signal arrival time matches the actual arrival time specified in the respective target arrival time data provided for that acoustic signal at step 604.

Training can be carried out by adjusting model parameters of the machine learning model to reduce an error between the model outputs and the target data, as is known in the art. This process is repeated until a sufficiently well trained model is obtained, as measured by a stopping criterion such as a convergence criterion, a criterion on the error or a pre-set number of epochs. Numerous programming languages and libraries are available to implement this process using a large variety of machine learning models. It will be appreciated by a skilled reader that a suitable model based on considerations such as available data and compute and the kind of data to be processed based on routine considerations can be chosen. The precise details of the training process at step 606 will vary based on these implementation details, as will be appreciated by a skilled reader. The ultimate outcome of the method of FIG. 6 is a machine learning model that has been trained to identify an arrival time of an acoustic signal at a receiver based on input acoustic signal data recorded by that receiver. A machine learning model trained in this manner can thus be used to implement the above described methods, with the ultimate aim of determining the velocity of a particular signal component and associated geodata parameters.

Turning to FIG. 7, an implementation of the method of FIG. 6 is shown in further detail in the context of a receiver, such as one of the receivers of probe 100 of FIG. 1. The training method of FIG. 7 has been developed by the present inventors and provides particularly effective training to enable a machine learning model to determine the arrival time of an acoustic signal at a sub-surface receiver.

The training method of FIG. 7 begins, at step 702, by obtaining acoustic data, which is representative of an acoustic signal recorded by a receiver of a probe located in a sub-surface ground volume. This data is used as the input data in the subsequent training process. It will be appreciated that step 702 therefore corresponds to step 602 of FIG. 6. As noted in reference to FIG. 6, the acoustic data may be data recorded by the first 102 or second 104 receiver in the probe 100 of FIG. 1, for example.

At step 704, the process obtains a target arrival time of the acoustic signal at the receiver. The target arrival time is used as the target or ground truth in the training process. It will be appreciated that step 704 therefore corresponds to step 604 of FIG. 6. Steps 706-712 then provide a more detailed description of the training process of step 606 of FIG. 6.

Beginning at step 706, the acoustic data obtained at step 702 is provided to a machine learning model. Responsive to this input, an output of the machine learning model is obtained at step 708. In particular, the output of the machine learning model comprises a determined arrival time of the acoustic signal at the receiver, which is determined based on the input data. In other words, the machine learning model takes as its input acoustic data recorded by a receiver and produces as its output an estimated arrival time of the acoustic signal at that receiver. For example, the machine learning model may output a predicted arrival time in milliseconds from a known start time or on a predetermined time scale.

At step 710, an error between the determined signal arrival time and the target signal arrival time is determined. This can be performed in any suitable manner through comparison of the output obtained at step 708 and the target data provided at step 704. Responsive to this determination, the method proceeds at step 712 to adjust parameters of the machine learning model with the aim of reducing the error determined at step 710.

The process of FIG. 7 can then repeated for further sets of acoustic signal data until a stopping criterion is met. For example, the method may be repeated N times, for a pre-set number of epochs or until a convergence criterion is satisfied. In implementations where there is more than one receiver, the process of FIG. 7 can be performed for each receiver that recorded the acoustic signal generated by the acoustic signal transmitter. The process of FIG. 7 can also be performed for each signal component generated by the active signal transmitter, for example the process can be performed for a compression-related component of the signal (e.g. P-wave) and/or a shear-related component of the signal (whether flexural wave or S-wave).

Once trained in this manner, the machine learning model can then be used to determine arrival times of signals for as-yet unseen and unlabelled audio data recordings, thereby replacing the need for human experts to label these signals. This not only means that signals can be analysed more quickly, but also improves the accuracy, reliability and consistency of the arrival time determination for the reasons described above. A method of using the trained machine learning model obtain an estimate of an arrival time of an acoustic signal at a sub-surface receiver will now be described with reference to FIG. 8.

At step 802, input data comprising acoustic data is obtained. In this case, the acoustic data represents an acoustic signal as recorded by a receiver of a probe located in a sub-surface ground volume, for example one of first 102 and second 104 receivers of probe 100 of FIG. 1. Step 802 therefore corresponds to step 602 of FIG. 6 and step 702 of FIG. 7, however because the method of FIG. 8 relates to a use-phase, rather than a training phase, in this case the obtained acoustic data is previously unseen acoustic data that has not yet been labelled to indicate the arrival time of the signal. The acoustic data can be obtained directly from the receiver or from a database, by any suitable wired or wireless means. As described in relation to steps 602 and 702, the obtained acoustic data again represents a recording of an acoustic signal generated by an active signal transmitter, such as the active signal transmitter 106 of probe 100 described in relation to FIG. 1. The acoustic signal data may comprise data representative of recorded acoustic signal traces of the sort shown in FIGS. 2-5.

At step 804, the input data (i.e. the acoustic data obtained at step 802) is provided to the trained machine learning model as an input. Where the model has been trained according to the methods of the present disclosure (in particular the methods of FIGS. 6 and 7 discussed above), the model can then proceed to determine an arrival time of the signal at the receiver based on the input acoustic data. This occurs at step 806, where the machine learning model outputs an estimated arrival time, (for example t₁ or t₂ discussed above), of the acoustic signal at the receiver.

Optionally, the method may then comprise further steps relating to processing the output of the machine learning model. In one example, the method proceeds to step 808 where a velocity of the signal represented by the obtained acoustic data is determined. As described above, the acoustic data may represent a particular component of the acoustic signal generated by the active signal transmitter, for example a compression or shear-related component. Based on the determined arrival time, the velocity of the signal component being analysed can be determined, resulting in an output of vₚ or vₛ. These calculated velocities may represent the velocity of the signal (component) between a transmitter and a receiver or, in the case of multiple receivers or multiple recording locations/depths, the average velocity (also known as the “interval velocity”) of the signal over the distance between a first and second receiver or between first and second recording locations/depths. Step 808 may be performed for each signal component, for example in order to obtain both a shear-related velocity, vₛ, and a compression-related velocity, vₚ.

Optionally, at step 810, the method may then further comprise calculating one or more geodata parameters based on the signal velocities determined at step 808. These geodata parameters may, for example, include the small strain Poisson's ratio, v, the small strain shear modulus, Gₘₐₓ, the small strain Young's modulus, Eₘₐₓ, and the bulk modulus K. Each of these parameters can be determined from vₛ and vₚ using the equations described above. Each determined parameter corresponds to a material property of the ground volume in which the receiver is provided and thus provides useful geological insight. More specifically, for two receivers in a down-hole probe 100 of the sort shown in FIG. 1, the determined geodata parameters are typically representative of the material properties of the cylindrical shell volume from the borehole wall to approximately 10 cm outwards, over the distance between the first 102 and second 104 receivers. The same is true for implementations where a single receiver is used to record acoustic data at two recording locations or depths. For single-receiver systems at a single depth, the calculated geodata parameters are representative of the material properties of the ground volume between the receiver and the transmitter. In each implementation, useful geodata about some ground volume of interest in the vicinity of the receiver(s) is provided.

The method of FIG. 8 can be repeated as many times as needed to account for processing multiple acoustic signal components (for example compression and shear-related components), as well as multiple signals (such as from multiple receivers like the first 102 and second 104 receivers of the probe 100 of FIG. 1 or from a single receiver recording data at multiple locations/depths).

All of the disclosed methods may be computer-implemented using a computing system or network, such as the example system described below with reference to FIG. 11. It will be appreciated that all the steps of FIGS. 6, 7 and 8 can be performed locally at the location where the probe 100 and/or transmitter 106 are provided, remotely at a different location (for example using a remote server or computing resource) or at a combination of both local and remote locations. With reference to FIG. 8, optional steps 808 and 810 may be performed by the same computing system or network performing steps 802-806, or these steps may be computed separately using different computational resources, optionally by a different party or entity that performed steps 802-806. Also, the training steps (i.e. FIGS. 6 and 7) can be performed at a different time or location and by a different entity or party than the use steps (i.e. FIG. 8). In other words, one party may train the machine learning model and then provide the trained model to another party for use.

### Variations

The above detailed description describes a variety of exemplary arrangements and methods for determining arrival times of acoustic signals at sub-surface receivers. However, the described arrangements and methods are merely exemplary, and it will be appreciated by a person skilled in the art that various modifications can be made without departing from the scope of the appended claims. Some of these modifications will now be briefly described, however this list of modifications is not to be considered as exhaustive, and other modifications will be apparent to a person skilled in the art.

As described above, in some implementations more than one set of acoustic signal data is generated, either by multiple receivers or by a single receiver that performs a signal recording at multiple locations/depths. Regardless of how the acoustic data sets are generated, the present inventors have discovered that it is beneficial in such implementations to provide the acoustic data sets from both (or all) receivers or locations/depths to the machine learning model as a combined input. This is true both during training of the machine learning model (e.g. as described in relation to FIGS. 6 and 7) and at use-time (e.g. as described in relation to FIG. 8). In other words, in this implementation, the input data provided to the machine learning model at either step 706 or 804 can comprise a combined input comprising acoustic signal data from more than one receiver or recorded by a single receiver at more than one location or depth. As noted above, providing the data as a “combined input” means that the acoustic data from each receiver or location is provided to the machine learning model as part of the same input which the machine learning model then treats in a uniform manner. In other words, the machine learning model analyses and labels both sets of acoustic data in a uniform manner when assigning an arrival time to each respective set of acoustic data. As noted above, the present inventors have determined that this strategy of providing the acoustic data from multiple receivers as a combined input improves the training or analysis process and results in more reliable and accurate determination of the signal arrival times, because the model effectively learns to recognise patterns and trends that are common to the signal as recorded at both the first receiver and the second receiver or at both the first and second locations/depths. Because each set of acoustic data is representative of either the same single signal or a similar signal generated at the active signal source, it is beneficial to train the machine learning model to treat the resulting acoustic data as being related.

The above discussion, in particular the signal traces of FIGS. 2-5, focussed for simplicity on waves with a single compression (i.e. P-wave) related component and shear (i.e. S-wave) related component. However, the present inventors have identified that it is advantageous to configure the active signal transmitter to generate two shear-related components that are oppositely polarised. As a result, the recorded acoustic signal data comprises data representative of two flexural waves that are oppositely polarised. Importantly, the present inventors have identified that this makes it easier for the machine learning model to assign an arrival time to the signal. An example of such acoustic data is shown in FIGS. 9 and 10. FIG. 9 shows a shear-related component (in this case a flexural wave) detected by a receiver, in this case the first receiver 102 of probe 100. FIG. 10 shows the same shear-related signal detected by the second receiver 104 of the probe. FIGS. 9 and 10 are therefore similar to FIGS. 4 and 5 discussed above, except in that now each set of acoustic data comprises two shear-related signals, in this example flexural waves. Because the flexural waves are oppositely polarised, their peaks and troughs approximately correspond to one another, making the signal arrival time easier to identify. Accordingly, the generation of an acoustic signal having two oppositely-polarised shear components enables the machine learning model to more accurately perform the determination of steps 708 and 806 described above. The signal prior to the arrival of the shear-related signal of interest comprises noise. When the shear-related waves are the signals of interest, the noise may comprise compression-related components and vice versa.

It will be appreciated that any suitable machine learning model may be used to implement the disclosed methods, and that the choice of machine learning model will impact how the determination of the signal arrival times is carried out. Generally, however, most approaches will involve the machine learning model analysing the acoustic signal (component) as represented in the input acoustic signal data and determining the arrival time of the acoustic signal by determining the point in the recorded signal when ambient background noise is superseded by or transitions into the recorded signal of interest. The transition point then represents the arrival time of the signal of interest. In other words, the machine learning model of the present disclosure may be configured to determine the arrival time of the acoustic signal by: separating the acoustic data into a noise portion and a signal portion; determining a transition point between the noise portion and the signal portion; and outputting the transition point as the estimated arrival time of the acoustic signal. This approach may be applied at training and/or use time. Separating the acoustic data into a noise portion and a signal portion may be performed in any suitable manner, for example using a segmentation-based approach or an image recognition-based approach. In other words, the model may be a signal processing model or an image recognition model. In either case, the appropriate machine learning model architecture will be employed. More generally, any suitable machine learning model can be used to implement the disclosed methods. One particularly suitable model is a Convolutional Neural Network (CNN). Long short-term memory (LSTM) networks, and more generally Recurrent Neural Network (RNN), could also be used.

In some implementations, the disclosed methods may be implemented in such a way as to facilitate effective quality control by a human reviewer or expert. In particular, the system may be configured to present, on a display, the estimated arrival time of an acoustic signal at a receiver as determined by the machine learning model. This enables a human reviewer to assess the determined arrival time output by the machine learning model and provide confirmatory or corrective inputs. For example, the system may receive an input from the reviewer confirming the arrival time determined by the machine learning model. Alternatively, the system may receive an input from the reviewer rejecting or correcting the arrival time determined by the machine learning model. This enables a human reviewer to interface with the determinations of the machine learning model and act as a filter or check on the outputs. This can be particularly useful and important during the training phase and can enable the reviewer to easily determine how well the machine learning model is performing and whether training is progressing appropriately. This functionality can also enable easy and effective auditing of previously trained models to ensure they are still performing as expected. In one particularly advantageous arrangement, presenting the estimated arrival time of an acoustic signal at a receiver as determined by the machine learning model may comprise presenting the signal trace representative of the acoustic signal (such as one of the traces shown in FIG. 2-5 or 9-10) and indicating, for example with a visual indicator or marker, the arrival time estimated by the machine learning model on the trace. This enables particularly simple and intuitive analysis of the determined arrival time by a reviewer.

As noted previously, the receiver(s) of the present disclosure can be provided below the ground surface in any suitable manner. However, as noted previously, one particularly beneficial implementation involves incorporating the receiver(s) into a probe, such as probe 100 of FIG. 1, and inserting the probe into the earth for example into a borehole. In one example, the probe may comprise an acoustic logging tool, one example of which is a P & S suspension logging (PSSL) tool which is a known type of tool particularly suitable for detecting compression (P-wave) and shear (S-wave) related signal components within a sub-surface volume. In another implementation, the probe may comprise a Seismic Cone Penetration Test (SCPT) tool which is a known type of tool for investigating sub-surface ground properties but which could readily be modified to incorporate acoustic receivers for performing the methods disclosed herein.

As noted above, the active signal transmitter can be any suitable form of transmitter configured to produce an acoustic (i.e. audio) signal in a controlled manner such that the signal can pass through a ground volume of interest and be recorded by suitable receivers.

The particular mechanism and method by which the acoustic signal data is recorded will vary based on the implementation and type of probe used. Generally, however, the method involves: inserting the probe comprising the one or more receivers into the sub-surface ground volume of interest; creating, using the active signal transmitter, the acoustic signal; and recording the acoustic signal at the one or more receivers to generate respective acoustic data for the one or more receivers that can then be input to the machine learning model as described above. All of the methods disclosed herein may be performed multiple times at a particular depth, and/or may be performed at multiple different depths in order to improve the reliability of the obtained data. The acoustic data recorded may be stored locally or remotely on any suitable computer storage component or server.

### Computer System

With reference now to FIG. 11, a computing device 1100 suitable for carrying out the methods described above will now be described. FIG. 11 shows a block diagram of one implementation of a processing system 1100 in the form of a computing device within which a set of instructions for causing the computing device to perform any one or more of the methodologies discussed herein, may be executed. In alternative implementations, the computing device may be connected (e.g., networked) to other machines in a Local Area Network (LAN), an intranet, an extranet, or the Internet. The computing device may operate in the capacity of a server or a client machine in a client-server network environment, or as a peer machine in a peer-to-peer (or distributed) network environment. The computing device may be a personal computer (PC), a tablet computer, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single computing device is illustrated, the term “computing device” shall also be taken to include any collection of machines (e.g., computers) that individually or jointly execute a set (or multiple sets) of instructions to perform any one or more of the methodologies discussed herein.

The example processing system 1100 includes a processor 1102, a main memory 1104 (e.g., read-only memory (ROM), flash memory, dynamic random access memory (DRAM) such as synchronous DRAM (SDRAM) or Rambus DRAM (RDRAM), etc.), a static memory 1106 (e.g., flash memory, static random access memory (SRAM), etc.), and a secondary memory (e.g., a data storage device 1118), which communicate with each other via a bus 1130.

Processor 1102 represents one or more general-purpose processors such as a microprocessor, central processing unit, or the like. More particularly, the processor 1102 may be a complex instruction set computing (CISC) microprocessor, reduced instruction set computing (RISC) microprocessor, very long instruction word (VLIW) microprocessor, processor implementing other instruction sets, or processors implementing a combination of instruction sets. Processor 1102 may also be one or more special-purpose processors such as an application specific integrated circuit (ASIC), a field programmable gate array (FPGA), a digital signal processor (DSP), network processor, or the like. Processor 1002 is configured to execute the processing logic (instructions 1122) for performing the operations and steps discussed herein.

The processing system 1100 may further include a network interface device 1008. The processing system 1100 also may include a video display unit 1110 (e.g., a liquid crystal display (LCD) or a cathode ray tube (CRT)), an alphanumeric input device 1112 (e.g., a keyboard or touchscreen), a cursor control device 1114 (e.g., a mouse or touchscreen), and an audio device 1016 (e.g., a speaker).

It will be apparent that some features of the processing system 1100 shown in FIG. 10 may be absent. For example, the processing system 1100 may have no need for display device 1110 (or any associated adapters). This may be the case, for example, for particular server-side computer apparatuses which are used only for their processing capabilities and do not need to display information to users. Similarly, user input device 1112 may not be required. In its simplest form, processing system 1100 comprises processor 1102 and main memory 1104.

The data storage device 1118 may include one or more machine-readable storage media (or more specifically one or more non-transitory computer-readable storage media) 1128 on which is stored one or more sets of instructions 1122 embodying any one or more of the methodologies or functions described herein. The instructions 1122 may also reside, completely or at least partially, within the main memory 1104 and/or within the processor 1002 during execution thereof by the processing system 1100, the main memory 1104 and the processor 1102 also constituting computer-readable storage media 1128.

The various methods described above may be implemented by a computer program. The computer program may include computer code arranged to instruct a computer to perform the functions of one or more of the various methods described above. The computer program and/or the code for performing such methods may be provided to an apparatus, such as a computer, on one or more computer readable media or, more generally, a computer program product. The computer readable media may be transitory or non-transitory. The one or more computer readable media could be, for example, an electronic, magnetic, optical, electromagnetic, infrared, or semiconductor system, or a propagation medium for data transmission, for example for downloading the code over the Internet. Alternatively, the one or more computer readable media could take the form of one or more physical computer readable media such as semiconductor or solid state memory, magnetic tape, a removable computer diskette, a random access memory (RAM), a read-only memory (ROM), a rigid magnetic disc, and an optical disk, such as a CD-ROM, CD-R/W or DVD.

The computer program is executable by the processor 1102 to perform functions of the systems and methods described herein.

In an implementation, the modules, components, and other features described herein can be implemented as discrete components or integrated in the functionality of hardware components such as ASICS, FPGAs, DSPs, or similar devices.

A “hardware component” is a tangible (e.g., non-transitory) physical component (e.g., a set of one or more processors) capable of performing certain operations and may be configured or arranged in a certain physical manner. A hardware component may include dedicated circuitry or logic that is permanently configured to perform certain operations. A hardware component may be or include a special-purpose processor, such as a field programmable gate array (FPGA) or an ASIC. A hardware component may also include programmable logic or circuitry that is temporarily configured by software to perform certain operations.

Accordingly, the phrase “hardware component” should be understood to encompass a tangible entity that may be physically constructed, permanently configured (e.g., hardwired), or temporarily configured (e.g., programmed) to operate in a certain manner or to perform certain operations described herein.

In addition, the modules and components can be implemented as firmware or functional circuitry within hardware devices. Further, the modules and components can be implemented in any combination of hardware devices and software components, or only in software (e.g., code stored or otherwise embodied in a machine-readable medium or in a transmission medium).

Unless specifically stated otherwise, as apparent from the following discussion, it is appreciated that throughout the description, discussions utilizing terms such as “receiving”, “determining”, “comparing”, “enabling”, “calculating”, “identifying”, “analysing”, “estimating”, “providing” or the like, refer to the actions and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

It is to be understood that the above description is intended to be illustrative, and not restrictive. Many other implementations will be apparent to those of skill in the art upon reading and understanding the above description. Although the present disclosure has been described with reference to specific example implementations, it will be recognized that the disclosure is not limited to the implementations described but can be practiced with modification and alteration within the spirit and scope of the appended claims. Accordingly, the specification and drawings are to be regarded in an illustrative sense rather than a restrictive sense. The scope of the disclosure should, therefore, be determined with reference to the appended claims, along with the full scope of equivalents to which such claims are entitled.

While at least one exemplary embodiment has been presented in the foregoing detailed description, it should be appreciated that a vast number of variations exist, only some of which have been mentioned above. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

1. A method comprising:
obtaining first acoustic data, wherein the first acoustic data represents an acoustic signal recorded by a first receiver of a probe located in a sub-surface ground volume, the acoustic signal generated by an active signal transmitter;
obtaining a target arrival time of the acoustic signal at the first receiver;
providing the first acoustic data to a machine learning model to obtain an output of the machine learning model, the output of the machine learning model comprising a determined arrival time of the acoustic signal at the first receiver; and
adjusting one or more parameters of the machine learning model to reduce an error between the determined arrival time and the target arrival time.

2. The method of claim 1, further comprising:
obtaining second acoustic data, wherein the second acoustic data represents the acoustic signal as recorded by a second receiver located in the sub-surface ground volume;
obtaining a second target arrival time of the acoustic signal at the second receiver;
providing the second acoustic data to the machine learning model to obtain a second output of the machine learning model, the second output of the machine learning model comprising a second arrival time of the acoustic signal at the second receiver; and
adjusting the one or more parameters of the machine learning model to reduce an error between the second arrival time and the second target arrival time for the second receiver.

3. The method of claim 1, further comprising:
obtaining second acoustic data, wherein the second acoustic data represents a second acoustic signal as recorded by the first receiver when located at a different location in the sub-surface ground volume;
obtaining a second target arrival time of the second acoustic signal at the first receiver;
providing the second acoustic data to the machine learning model to obtain a second output of the machine learning model, the second output of the machine learning model comprising a second arrival time of the second acoustic signal at the first receiver; and
adjusting the one or more parameters of the machine learning model to reduce an error between the second arrival time and the target arrival time for the second acoustic signal at the first receiver.

4. The method of claim 2, wherein the first acoustic data and the second acoustic data are provided to the machine learning model as a combined input.

5. The method of claim 2, wherein the first acoustic data and/or the second acoustic data comprises data representative of a compression-related signal component and/or a shear-related signal component.

6. The method of claim 1, wherein for each input acoustic data the machine learning model is configured to determine a respective arrival time of the acoustic signal at the respective receiver by:
separating the input acoustic data into a noise portion and a signal portion;
determining a transition point between the noise portion and the signal portion; and
outputting the transition point as estimated arrival time of the acoustic signal.

7. A method comprising:
obtaining input data comprising first acoustic data, wherein the first acoustic data represents an acoustic signal recorded by a first receiver of a probe located in a sub-surface ground volume, said acoustic signal generated by an active signal transmitter; and
applying the input data to a machine learning model to obtain an output of the machine learning model as an estimate.

8. The method of claim 7,
wherein the input data further comprises second acoustic data, wherein the second acoustic data represents the acoustic signal as recorded by a second receiver located in the sub-surface ground volume, and
wherein the output of the machine learning model further comprises an estimate of an arrival time of the acoustic signal at the second receiver.

9. The method of claim 8, further comprising:
based on the estimated arrival time of the acoustic signal at the first receiver and the second receivers and a known distance between the first receiver and the second receiver, determining an interval velocity of one or more components of the acoustic signal.

10. The method of claim 7,
wherein the input data further comprises second acoustic data, wherein the second acoustic data represents a second acoustic signal as recorded by the first receiver of the probe when located at a different location in the sub-surface ground volume, and
wherein the output of the machine learning model further comprises an estimate of an arrival time of the second acoustic signal at the first receiver.

11. The method of claim 10, further comprising:
based on the estimated arrival time of the first acoustic signal and the second acoustic signals at the first receiver and a known distance between the different locations in the sub-surface ground volume where the first receiver respectively detected the first acoustic signal and the second acoustic signals, determining an interval velocity of one or more components of the second acoustic signal.

12. The method of claim 9, further comprising:
calculating, based on the determined interval velocity of the one or more components of the acoustic signal, one or more parameters associated with the sub-surface ground volume.

13. The method of claim 8, wherein the first acoustic data and the second acoustic data are provided to the machine learning model as a combined input.

14. The method of claim 10, further comprising:
presenting, on a display, the estimated arrival time of the first acoustic signal and/or the second acoustic signal at the first receiver and/or the second receiver.

15. The method of claim 7, wherein:
the probe is provided in a sub-surface borehole; and/or
the probe comprises a P & S suspension logging (PSSL) tool or a Seismic Cone Penetration Test (SCPT) tool; and/or
the probe comprises the active signal transmitter; and/or
the machine learning model comprises a Convolutional Neural Network (CNN).

16. The method of claim 7, wherein obtaining the input data comprising the first acoustic data comprises:
inserting the probe comprising the first receiver into the sub-surface ground volume;
creating, using the active signal transmitter, the acoustic signal; and
recording the acoustic signal at the first receiver to generate the first acoustic data.

17. A system comprising one or more processors and one or more memories having stored thereon computer readable instructions configured to cause the one or more processors to:
obtain first acoustic data, wherein the first acoustic data represents an acoustic signal recorded by a first receiver of a probe located in a sub-surface ground volume, the acoustic signal generated by an active signal transmitter;
obtain a target arrival time of the acoustic signal at the first receiver;
provide the first acoustic data to a machine learning model to obtain an output of the machine learning model, the output of the machine learning model comprising a determined arrival time of the acoustic signal at the first receiver; and
adjust one or more parameters of the machine learning model to reduce an error between the determined arrival time and the target arrival time.

18. The system of claim 17, further comprising instructions configured to cause the one or more processors to:
obtain second acoustic data, wherein the second acoustic data represents the acoustic signal as recorded by a second receiver located in the sub-surface ground volume;
obtain a second target arrival time of the acoustic signal at the second receiver;
provide the second acoustic data to the machine learning model to obtain a second output of the machine learning model, the second output of the machine learning model comprising a second arrival time of the acoustic signal at the second receiver; and
adjust the one or more parameters of the machine learning model to reduce an error between the second arrival time and the second target arrival time for the second receiver.

19. The system of claim 17, further comprising instructions configured to cause the one or more processors to:
obtain second acoustic data, wherein the second acoustic data represents a second acoustic signal as recorded by the first receiver when located at a different location in the sub-surface ground volume;
obtain a second target arrival time of the second acoustic signal at the first receiver;
provide the second acoustic data to the machine learning model to obtain a second output of the machine learning model, the second output of the machine learning model comprising a second arrival time of the second acoustic signal at the first receiver; and
adjust the one or more parameters of the machine learning model to reduce an error between the second arrival time and the target arrival time for the second acoustic signal at the first receiver.

20. The system of claim 18, wherein the first acoustic data and the second acoustic data are provided to the machine learning model as a combined input.
